(19) United States
(12) Patent Application Publication
(10) Pub. No.: US 2025/0069128 A1
(43) Pub. Date: Feb. 27, 2025

(54) SYSTEMS AND METHODS FOR PREDICTING RELEVANT SEARCH QUERY CATEGORIZATIONS AND LOCALE PREFERENCES

(71) Applicant: Optum Services (Ireland) Limited, Dublin (IE)

(72) Inventors: Ayush Tomar, Morgan Hill, CA (US); Ketki Savle, Atlanta, GA (US); Huzaifa Sial, Emeryville, CA (US); Yizhao Ni, Centennial, CO (US); Cem Unsal, Alameda, CA (US); Vinit Garg, Fremont, CA (US); Michael Zhou, West Hartford, CT (US)

(21) Appl. No.: 18/588,776

(22) Filed: Feb. 27, 2024

Related U.S. Application Data
(60) Provisional application No. 63/578,457, filed on Aug. 24, 2023.

(51) Int. Cl. G06Q 30/0601

(52) U.S. Cl. CPC G06Q 30/0625; G06Q 30/0639

(57) ABSTRACT

Various embodiments of the present disclosure provide methods, apparatus, systems, computing devices, computing entities, and/or the like for ranking entities provided in response to a search query by identifying one or more categorical identifiers based on a semantic similarity between a query embedding and a plurality of categorical description embeddings, generating a predicted distance preference for the search query based on a location associated with a querying user, identifying one or more entities based on the location associated with the querying user, the predicted distance preference, and entity activity data entries comprising a plurality of categorical descriptions matching the identified one or more categorical identifiers.

### CROSS REFERENCE TO RELATED APPLICATION

This application claims the priority of U.S. Provisional Application No. 63/578,457, entitled “PROVIDER RANKING SIGNALS USING CLAIMS DATA,” filed on Aug. 24, 2023, the disclosure of which is hereby incorporated by reference in its entirety.

### BACKGROUND

An information retrieval system may be tasked with identifying content, such as goods or services, that matches a search query. The search query may comprise keywords that are extracted and used by the information retrieval system to match with terms associated with the content. However, conventional information retrieval systems are unable to determine an exact intent of a querying user from a search query alone, especially when the intent of the querying user may be based on a geographic factor. For example, a query for goods or services may comprise a location component where the querying user intends to travel to a site to purchase or obtain the goods or services.

Various embodiments of the present disclosure address technical challenges related to performing predictive data analysis and user-based contextual ranking of search results to address the relevancy shortcomings of existing information retrieval systems.

### BRIEF SUMMARY

In general, various embodiments of the present disclosure provide methods, apparatus, systems, computing devices, computing entities, and/or the like for retrieving search results in response to a search query.

Various embodiments of the present disclosure make important technical contributions to improving predictive accuracy of predictive machine learning models used in generating search results for search queries by generating search query embeddings based on inferred associations from past user activities. As described herein, users who enter search queries into a search retrieval system often want to receive the most relevant search results pertaining to the intent of their search queries. Accordingly, by training a transformer machine learning model to map search queries to categorical descriptions based on a user's historical query response interactions and activity data entries comprising one or more confirming actions of the user, the techniques described herein improve textual embeddings of search queries, leading to higher accuracy of performing predictive operations as needed on generating responses to the search queries.

In some embodiments, a computer-implemented method comprises: receiving, by one or more processors, one or more search queries from a user; determining, by the one or more processors and using a transformer machine learning model, one or more categorical identifiers for the one or more search queries based on one or more matches of the one or more search queries to one or more categorical descriptions associated with the one or more categorical identifiers; determining, by the one or more processors, a user locale associated with the user; determining, by the one or more processors, one or more distance preferences of the user locale based on one or more mappings of the one or more categorical identifiers to one or more statistical distances associated with the user locale; determining, by the one or more processors, one or more search radii based on the one or more distance preferences and the one or more categorical identifiers; identifying, by the one or more processors, one or more entities based on (i) one or more entity activity data entries associated with the one or more entities that match the one or more categorical identifiers and (ii) the one or more search radii; and generating, by the one or more processors, one or more responses to the one or more search queries based on the one or more entities.

In some embodiments, a computing system comprising memory and one or more processors communicatively coupled to the memory, the one or more processors configured to: receive one or more search queries from a user; determine, using a transformer machine learning model, one or more categorical identifiers for the one or more search queries based on one or more matches of the one or more search queries to one or more categorical descriptions associated with the one or more categorical identifiers; determine a user locale associated with the user; determine one or more distance preferences of the user locale based on one or more mappings of the one or more categorical identifiers to one or more statistical distances associated with the user locale; determine one or more search radii based on the one or more distance preferences and the one or more categorical identifiers; identify one or more entities based on (i) one or more entity activity data entries associated with the one or more entities that match the one or more categorical identifiers and (ii) the one or more search radii; and generate one or more responses to the one or more search queries based on the one or more entities.

In some embodiments, one or more non-transitory computer-readable storage media including instructions that, when executed by one or more processors, cause the one or more processors to receive one or more search queries from a user; determine, using a transformer machine learning model, one or more categorical identifiers for the one or more search queries based on one or more matches of the one or more search queries to one or more categorical descriptions associated with the one or more categorical identifiers; determine a user locale associated with the user; determine one or more distance preferences of the user locale based on one or more mappings of the one or more categorical identifiers to one or more statistical distances associated with the user locale; determine one or more search radii based on the one or more distance preferences and the one or more categorical identifiers; identify one or more entities based on (i) one or more entity activity data entries associated with the one or more entities that match the one or more categorical identifiers and (ii) the one or more search radii; and generate one or more responses to the one or more search queries based on the one or more entities.

### BRIEF DESCRIPTION OF THE DRAWINGS

FIG. 1 provides an example overview of an architecture in accordance with some embodiments of the present disclosure.

FIG. 2 provides an example predictive data analysis computing entity in accordance with some embodiments of the present disclosure.

FIG. 3 provides an example client computing entity in accordance with some embodiments of the present disclosure.

FIG. 4 is a flowchart diagram of an example process for retrieving search results for search queries in accordance with some embodiments of the present disclosure.

FIG. 5 is a flowchart diagram of an example process for determining categorical identifiers for search queries in accordance with some embodiments of the present disclosure.

FIG. 6 is a flowchart diagram of an example process for mapping categorical identifiers to statistical distances in accordance with some embodiments of the present disclosure.

### DETAILED DESCRIPTION

Various embodiments of the present disclosure are described more fully hereinafter with reference to the accompanying drawings, in which some, but not all embodiments of the present disclosure are shown. Indeed, the present disclosure may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “example” are used to be examples with no indication of quality level. Terms such as “computing,” “determining,” “generating,” and/or similar words are used herein interchangeably to refer to the creation, modification, or identification of data. Further, “based on,” “based at least in part on,” “based at least on,” “based upon,” and/or similar words are used herein interchangeably in an open-ended manner such that they do not necessarily indicate being based only on or based solely on the referenced element or elements unless so indicated. Like numbers refer to like elements throughout.

### I. Computer Program Products, Methods, and Computing Entities

Embodiments of the present disclosure may be implemented in various ways, including as computer program products that comprise articles of manufacture. Such computer program products may include one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages include, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form. A software component may be stored as a file or other data storage construct. Software components of a similar type or functionally related may be stored together such as, for example, in a particular directory, folder, or library. Software components may be static (e.g., pre-established or fixed) or dynamic (e.g., created or modified at the time of execution).

A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

A non-volatile computer-readable storage medium may include a floppy disk, flexible disk, hard disk, solid-state storage (SSS) (e.g., a solid-state drive (SSD), solid-state card (SSC), solid-state module (SSM)), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

A volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may also be implemented as methods, apparatus, systems, computing devices, computing entities, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may also take the form of an entirely hardware embodiment, an entirely computer program product embodiment, and/or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically-configured machines performing the steps or operations specified in the block diagrams and flowchart illustrations. Accordingly, the block diagrams and flowchart illustrations support various combinations of embodiments for performing the specified instructions, operations, or steps.

### II. Example Framework

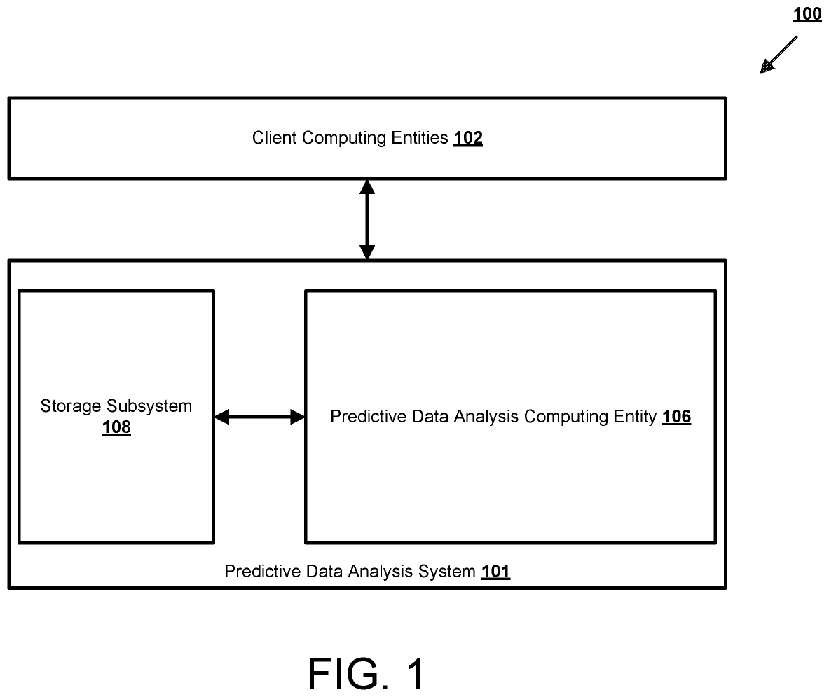

FIG. 1 provides an example overview of an architecture in accordance with some embodiments of the present disclosure. The architecture 100 includes a predictive data analysis system 101 configured to receive predictive data analysis/search requests from client computing entities 102, process the predictive data analysis/search requests to generate predictions and/or retrieve search results based on the generated predictions, and provide the generated predictions and/or search results to the client computing entities 102. The example architecture 100 may be used in a plurality of domains and not limited to any specific application as disclosed herewith. The plurality of domains may include banking, healthcare, industrial, manufacturing, education, retail, to name a few.

In accordance with various embodiments of the present disclosure, a transformer machine learning model may be trained to map search queries to categorical descriptions based on a user's historical query response interactions and activity data entries comprising one or more confirming actions of the user. This technique will improve textual embeddings of search queries, leading to higher accuracy of performing predictive operations as needed on generating responses to the search queries. In doing so, the techniques described herein improve efficiency and speed of training predictive machine learning models, thus reducing the number of computational operations needed and/or the amount of training data entries needed to train predictive machine learning models. Accordingly, the techniques described herein improve the computational efficiency, storage-wise efficiency, and/or speed of training predictive machine learning models. In further embodiments, an information retrieval system may dynamically expand or vary a search radius based on user preferences between distance and categorical identifiers. As such, retrieval criteria and an amount of relevant results may be varied by distance to account for a subject of a search query, thus improving the accuracy and performance of information retrieval systems.

In some embodiments, predictive data analysis system 101 may communicate with at least one of the client computing entities 102 using one or more communication networks. Examples of communication networks include any wired or wireless communication network including, for example, a wired or wireless local area network (LAN), personal area network (PAN), metropolitan area network (MAN), wide area network (WAN), or the like, as well as any hardware, software, and/or firmware required to implement it (such as, e.g., network routers, and/or the like).

The predictive data analysis system 101 may include a predictive data analysis computing entity 106 and a storage subsystem 108. The predictive data analysis computing entity 106 may be configured to receive predictive data analysis/search requests from client computing entities 102, process the predictive data analysis/search requests to generate predictions and/or retrieve search results based on the generated predictions, and provide the generated predictions and/or search results to the client computing entities 102.

The storage subsystem 108 may be configured to store input data used by the predictive data analysis computing entity 106 to perform predictive data analysis as well as model definition data used by the predictive data analysis computing entity 106 to perform various predictive data analysis tasks. The storage subsystem 108 may include one or more storage units, such as multiple distributed storage units that are connected through a computer network. Each storage unit in the storage subsystem 108 may store at least one of one or more data assets and/or one or more data about the computed properties of one or more data assets. Moreover, each storage unit in the storage subsystem 108 may include one or more non-volatile storage or memory media including, but not limited to, hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like.

### A. Example Predictive Data Analysis Computing Entity

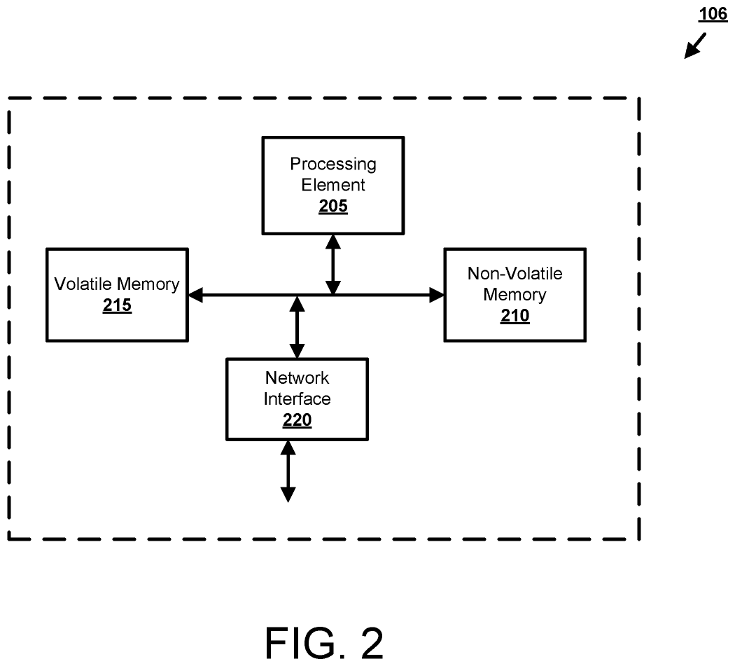

FIG. 2 provides an example predictive data analysis computing entity in accordance with some embodiments of the present disclosure. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In some embodiments, these functions, operations, and/or processes may be performed on data, content, information, and/or similar terms used herein interchangeably.

As shown in FIG. 2, in some embodiments, the predictive data analysis computing entity 106 may include, or be in communication with, one or more processing elements 205 (also referred to as processors, processing circuitry, and/or similar terms used herein interchangeably) that communicate with other elements within the predictive data analysis computing entity 106 via a bus, for example. As will be understood, the processing element 205 may be embodied in a number of different ways.

For example, the processing element 205 may be embodied as one or more complex programmable logic devices (CPLDs), microprocessors, multi-core processors, coprocessing entities, application-specific instruction-set processors (ASIPs), microcontrollers, and/or controllers. Further, the processing element 205 may be embodied as one or more other processing devices or circuitry. The term circuitry may refer to an entirely hardware embodiment or a combination of hardware and computer program products. Thus, the processing element 205 may be embodied as integrated circuits, application specific integrated circuits (ASICs), field programmable gate arrays (FPGAs), programmable logic arrays (PLAs), hardware accelerators, other circuitry, and/or the like.

As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present disclosure when configured accordingly.

In some embodiments, the predictive data analysis computing entity 106 may further include, or be in communication with, non-volatile media (also referred to as non-volatile storage, memory, memory storage, memory circuitry, and/or similar terms used herein interchangeably). In some embodiments, the non-volatile storage or memory may include one or more non-volatile memory 210, including, but not limited to, hard disks, ROM, PROM, EPROM, EEPROM, flash memory, MMCs, SD memory cards, Memory Sticks, CBRAM, PRAM, FORAM, NVRAM, MRAM, RRAM, SONOS, FJG RAM, Millipede memory, racetrack memory, and/or the like.

As will be recognized, the non-volatile storage or memory media may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity-relationship model, object model, document model, semantic model, graph model, and/or the like.

In some embodiments, the predictive data analysis computing entity 106 may further include, or be in communication with, volatile media (also referred to as volatile storage, memory, memory storage, memory circuitry, and/or similar terms used herein interchangeably). In some embodiments, the volatile storage or memory may also include one or more volatile memory 215, including, but not limited to, RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like.

As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, the processing element 205. Thus, the databases, database instances, database management systems, data, applications, programs, program modules, scripts, source code, object code, byte code, compiled code, interpreted code, machine code, executable instructions, and/or the like may be used to control certain aspects of the operation of the predictive data analysis computing entity 106 with the assistance of the processing element 205 and operating system.

As indicated, in some embodiments, the predictive data analysis computing entity 106 may also include one or more network interfaces 220 for communicating with various computing entities, such as by communicating data, content, information, and/or similar terms used herein interchangeably that may be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the predictive data analysis computing entity 106 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1X (1xRTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the predictive data analysis computing entity 106 may include, or be in communication with, one or more input elements, such as a keyboard input, a mouse input, a touch screen/display input, motion input, movement input, audio input, pointing device input, joystick input, keypad input, and/or the like. The predictive data analysis computing entity 106 may also include, or be in communication with, one or more output elements (not shown), such as audio output, video output, screen/display output, motion output, movement output, and/or the like.

### B. Example Client Computing Entity

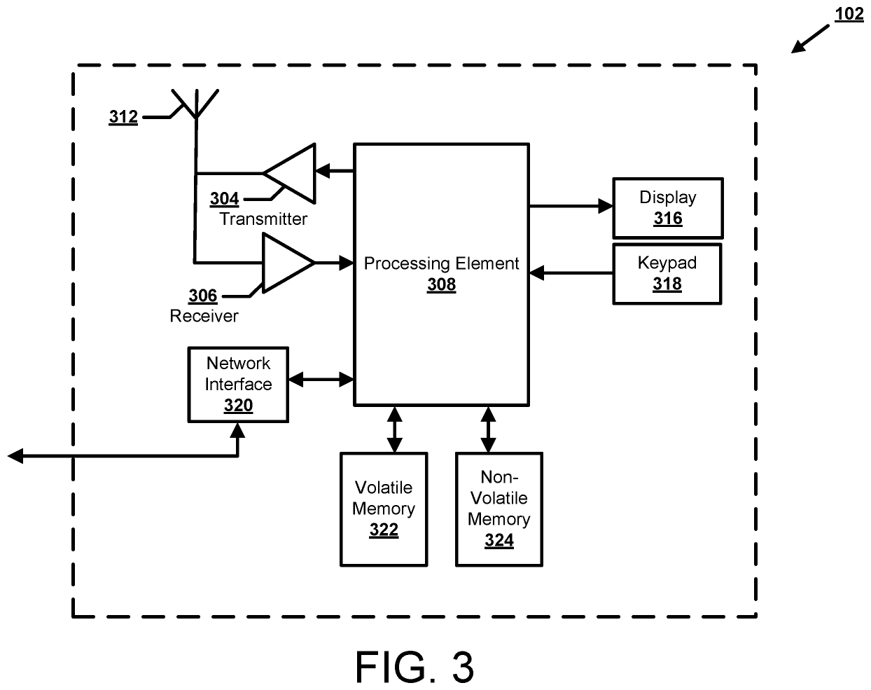

FIG. 3 provides an example client computing entity in accordance with some embodiments of the present disclosure. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Client computing entities 102 may be operated by various parties. As shown in FIG. 3, the client computing entity 102 may include an antenna 312, a transmitter 304 (e.g., radio), a receiver 306 (e.g., radio), and a processing clement 308 (e.g., CPLDs, microprocessors, multi-core processors, coprocessing entities, ASIPs, microcontrollers, and/or controllers) that provides signals to and receives signals from the transmitter 304 and receiver 306, correspondingly.

The signals provided to and received from the transmitter 304 and the receiver 306, correspondingly, may include signaling information/data in accordance with air interface standards of applicable wireless systems. In this regard, the client computing entity 102 may be capable of operating with one or more air interface standards, communication protocols, modulation types, and access types. More particularly, the client computing entity 102 may operate in accordance with any of a number of wireless communication standards and protocols, such as those described above with regard to the predictive data analysis computing entity 106. In some embodiments, the client computing entity 102 may operate in accordance with multiple wireless communication standards and protocols, such as UMTS, CDMA2000, 1xRTT, WCDMA, GSM, EDGE, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the client computing entity 102 may operate in accordance with multiple wired communication standards and protocols, such as those described above with regard to the predictive data analysis computing entity 106 via a network interface 320.

Via these communication standards and protocols, the client computing entity 102 may communicate with various other entities using mechanisms such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The client computing entity 102 may also download changes, add-ons, and updates, for instance, to its firmware, software (e.g., including executable instructions, applications, program modules), and operating system.

According to some embodiments, the client computing entity 102 may include location determining aspects, devices, modules, functionalities, and/or similar words used herein interchangeably. For example, the client computing entity 102 may include outdoor positioning aspects, such as a location module adapted to acquire, for example, latitude, longitude, altitude, geocode, course, direction, heading, speed, universal time (UTC), date, and/or various other information/data. In some embodiments, the location module may acquire data, sometimes known as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data may be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data may be determined by triangulating the position of the client computing entity 102 in connection with a variety of other systems, including cellular towers, Wi-Fi access points, and/or the like. Similarly, the client computing entity 102 may include indoor positioning aspects, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops), and/or the like. For instance, such technologies may include the iBeacons, Gimbal proximity beacons, Bluetooth Low Energy (BLE) transmitters, NFC transmitters, and/or the like. These indoor positioning aspects may be used in a variety of settings to determine the location of someone or something to within inches or centimeters.

The client computing entity 102 may also comprise a user interface (that may include a display 316 coupled to a processing element 308) and/or a user input interface (coupled to a processing element 308). For example, the user interface may be a user application, browser, user interface, and/or similar words used herein interchangeably executing on and/or accessible via the client computing entity 102 to interact with and/or cause display of information/data from the predictive data analysis computing entity 106, as described herein. The user input interface may comprise any of a number of devices or interfaces allowing the client computing entity 102 to receive data, such as a keypad 318 (hard or soft), a touch display, voice/speech or motion interfaces, or other input device. In embodiments including a keypad 318, the keypad 318 may include (or cause display of) the conventional numeric (0-9) and related keys (#, *), and other keys used for operating the client computing entity 102 and may include a full set of alphabetic keys or set of keys that may be activated to provide a full set of alphanumeric keys. In addition to providing input, the user input interface may be used, for example, to activate or deactivate certain functions, such as screen savers and/or sleep modes.

The client computing entity 102 may also include volatile memory 322 and/or non-volatile memory 324, which may be embedded and/or may be removable. For example, the non-volatile memory 324 may be ROM, PROM, EPROM, EEPROM, flash memory, MMCs, SD memory cards, Memory Sticks, CBRAM, PRAM, FORAM, NVRAM, MRAM, RRAM, SONOS, FJG RAM, Millipede memory, racetrack memory, and/or the like. The volatile memory 322 may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile memory may store databases, database instances, database management systems, data, applications, programs, program modules, scripts, source code, object code, byte code, compiled code, interpreted code, machine code, executable instructions, and/or the like to implement the functions of the client computing entity 102. As indicated, this may include a user application that is resident on the client computing entity 102 or accessible through a browser or other user interface for communicating with the predictive data analysis computing entity 106 and/or various other computing entities.

In another embodiment, the client computing entity 102 may include one or more components or functionalities that are the same or similar to those of the predictive data analysis computing entity 106, as described in greater detail above. As will be recognized, these architectures and descriptions are provided for example purposes only and are not limiting to the various embodiments.

In various embodiments, the client computing entity 102 may be embodied as an artificial intelligence (AI) computing entity, such as an Amazon Echo, Amazon Echo Dot, Amazon Show, Google Home, and/or the like. Accordingly, the client computing entity 102 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage module, and/or accessible over a network. In various embodiments, the AI computing entity may be configured to retrieve and/or execute one or more of the predefined program algorithms upon the occurrence of a predefined trigger event.

### III. Examples of Certain Terms

In some embodiments, the term “search query” refers to a data construct that describes a request for information. A search query may comprise one or more keywords, phrases, characters, numbers, symbols, or any combination thereof. According to various embodiments of the present disclosure, search queries may be received by a predictive data analysis system from one or more client computing entities, either directly or indirectly via, e.g., an information retrieval system comprising a search engine.

In some embodiments, the term “embedding” refers to a data construct that describes a latent representation of data comprising one or more features. For example, an embedding of data may be expressed as a vector comprising one or more numbers representative of one or more features associated with content of the data. In some embodiments, an embedding may be generated by mapping one or more features to one or more elements in a vector space. According to various embodiments of the present disclosure, an embedding comprises a feature associated with machine learning model input data. One or more embeddings may be generated for machine learning model input data such that the machine learning model input data may be provided in a format suitable for analysis or processing by a machine learning model. According to various embodiments of the present disclosure, one or more embeddings of search queries and categorical descriptions are generated by a machine learning model comprising a transformer machine learning model such that the search queries and categorical descriptions may be provided in a format suitable for comparison by the transformer machine learning model.

In some embodiments, the term “search query embedding” refers to an embedding of a search query. That is, a search query embedding may comprise a latent representation of a search query and may be expressed as a vector comprising one or more numbers representative of one or more features associated with the search query. In some embodiments, a search query embedding may be generated by a transformer machine learning model. A search query embedding may be generated of a search query to perform semantic matching of the search query to one or more categorical descriptions. For example, semantic matching of a search query to one or more categorical descriptions may be performed based on a comparison, e.g., using a transformer machine learning model, between a search query embedding associated with a search query and one or more categorical description embeddings associated with respective ones of the one or more categorical descriptions.

In some embodiments, the term “categorical description” refers to a data construct that describes one or more keywords, numbers, or phrases associated with a classification according to a given taxonomy. One or more categorical descriptions may be associated with an entity to describe one or more goods or services provided by the entity. According to various embodiments of the present disclosure, one or more search queries may be matched to one or more categorical descriptions, and based on the matching, one or more categorical identifiers may be determined and used to identify one or more entities for responding to the one or more search queries. In one example embodiment, a categorical description may comprise a description of diagnostic codes (e.g., International Classification of Diseases (ICD) or Current Procedural Terminology (CPT) codes) associated with diagnoses or treatments healthcare providers may perform.

In some embodiments, the term “categorical description embedding” refers to an embedding of a categorical description. That is, a categorical description embedding may comprise a latent representation of a categorical description and may be expressed as a vector comprising one or more numbers representative of one or more features associated with the categorical description. In some embodiments, a categorical description embedding may be generated by a transformer machine learning model. A categorical description embedding may be generated of a categorical description to perform semantic matching of the categorical description to a search query. For example, semantic matching of a search query to one or more categorical descriptions may be performed based on a comparison, e.g., using a transformer machine learning model, between a search query embedding associated with a search query and one or more categorical description embeddings associated with respective ones of the one or more categorical descriptions.

In some embodiments, the term “categorical identifier” refers to a data construct that describes a sequence of characters, numbers, symbols, or any combination thereof associated with a categorical description. According to various embodiments of the present disclosure, one or more categorical identifiers are determined for a search query according to one or more categorical descriptions matching the search query, and one or more entities are identified or retrieved in response to the search query based on the one or more categorical identifiers matching one or more entity activity data entries associated with the one or more entities. The determined one or more categorical identifiers may comprise categorical identifiers that are similar to the search query based on one or more matches of one or more categorical descriptions associated with the one or more categorical identifiers to the search query. In some embodiments, distance preferences of users in certain locales for specific categorical identifiers may be determined by mapping categorical identifiers to respective statistical distances associated with user locales based on entity activity data entries associated with the users. In one example embodiment, categorical identifiers may comprise diagnostic codes (e.g., International Classification of Diseases (ICD) or Current Procedural Terminology (CPT) codes) associated with diagnoses or treatments healthcare providers may perform.

In some embodiments, the term “locale” refers to a data construct that describes a geographic location, place, or region.

In some embodiments, the term “user locale” refers to a locale of a user. For example, a user locale associated with a user may comprise a zip code of the user. A user locale of a user may be determined based on user activity data entries associated with the user. In some embodiments, a distance preference is determined for a user of a search query based on a mapping of one or more categorical identifiers to respective one or more statistical distances associated with a user locale of the user.

In some embodiments, the term “entity locale” refers to a locale of an entity. For example, an entity locale associated with an entity may comprise a zip code of the entity. An entity locale associated with an entity may be determined and used to determine one or more statistical distances associated with one or more user locales. For example, a statistical distance may comprise an average of distances between user locales and entity locales based on user activity data entries.

In some embodiments, the term “distance preference” refers to a data construct that describes a propensity or inclination of users associated with a given locale selecting (e.g., either via a historical query response interaction or a user activity data entry) search results comprising entities comprising entity locales that are within a certain distance from the given locale. For example, a distance preference may comprise a distance that a typical user of a certain user locale is willing to travel to obtain particular goods or services. A distance preference for a user locale may be determined based on a mapping of one or more categorical identifiers to one or more statistical distances associated with the user locale. In some embodiments, the one or more mappings comprises a mapping for each of a plurality of user locales, for each of one or more categorical identifiers, to a statistical distance based on a plurality of user activity data entries associated with a plurality of users belonging to the plurality of user locales. In some embodiments, a plurality of mappings of user locales to statistical distances associated with given categorical identifiers may be generated by (i) extracting, from user activity data entries for each user, a user locale, such as a user zip code location zᵤ, (ii) determining, for each entity present in the user activity data entries of the user, an entity locale, such as an entity zip code zₚ and a categorical identifier, such as a 3-character ICD code i given by the entity during an interaction with the user, (iii) determining an approximate distance between the user locale and the entity locale (e.g., zᵤ and zₚ), and (iv) mapping the approximate distance between the user locale and the entity locale to the categorical identifier (e.g., ICD code i).

In some embodiments, the term “statistical distance” refers to a data construct that describes a representative distance between a plurality of locales, such as between a user locale and an entity locale. According to various embodiments of the present disclose, a statistical distance comprises an aggregate distance calculated (e.g., average, median, or mode) between a particular user locale and an entity locale based on a plurality of user activity data entries comprising a plurality of users associated with the user locale and one or more entities associated with respective one or more entity locales. As such, the statistical distance may comprise a typical distance between a user of a certain user locale and an entity of a certain entity locale the user will interact with (e.g., visit).

In some embodiments, the term “search radius” refers to a data construct that describes a search parameter associated with a distance of one or more entities, e.g., associated with one or more search results for a search query, from a user locale of a user providing the search query. According to various embodiments of the present disclosure, a search radius may be determined for a search query based on a distance preference of a user providing the search query and one or more categorical identifiers matched to a search query. For example, a search radius for a given search query may be determined or modified for a user's search query based the user's user locale (e.g., their zip code) and one or more categorical identifiers (e.g., best 3-character ICD code(s)) matched to the given search query. In some embodiments, an information retrieval system comprising a search engine may be configured to receive a search query from a user and determine a search radius for the search query that is specific to the user's locale. The search radius determined for the search query may be used to identify one or more entities in response to the search query by retrieving entities within the search radius comprising entity activity data entries associated with one or more categorical identifiers matching the search query.

In some embodiments, the term “entity” refers to a data construct that describes a data object, article, file, program, service, task, operation, computing entity, and/or the like unit comprising a source of goods or services. For example, an entity may comprise a healthcare provider that may be identified and retrieved in response to search queries. In some embodiments, a user may provide a search query from a client computing entity to an information retrieval system comprising a search engine, and in response to the search query, one or more entities may be identified and returned to the client computing entity, e.g., as search results for the search query. According to various embodiments of the present disclosure, one or more entities are identified based on (i) one or more entity activity data entries associated with the one or more entities that match the one or more categorical identifiers and (ii) one or more search radii. In some embodiments, one or more responses to one or more search queries may be generated based on the one or more entities.

In some embodiments, the term “entity activity data entry” refers to a data construct that describes a bill of sale, receipt, or confirmation associated with an activity between an entity and a user. The activity may comprise a transaction or interaction and one or more categorical identifiers or categorical descriptions describing goods or services provided by an entity to a user at a specific date/time and location (e.g., entity locale). In some embodiments, an entity activity data entry may comprise claims data including information such as, diagnoses, procedures, or treatments (e.g., in the form of ICD and/or CPT codes) performed by a healthcare provider (entity) on a user. In some embodiments, an entity activity data entry may also comprise an entity locale at which an entity commenced in an activity with a user. In some embodiments, an entity locale of an entity may be determined from an entity activity data entry associated with the entity and used to determine one or more statistical distances from a plurality of aggregate users associated with one or more user locales. According to various embodiments of the present disclosure, entity activity data entries may be analyzed and used to identify one or more entities for generating a response to a search query. In some embodiments, for each of one or more entities within a search radius, an entity may be identified based on one or more entity activity data entries associated with the one or more entities matching one or more categorical identifiers that match the search query. In some embodiments, generating a response to a search query further comprises determining counts of entity activity data entries that match the one or more categorical identifiers within a time window and ranking the one or more entities based thereof. The counts may be normalized, and the one or more entities may be sorted and ranked for relevancy to the search query based on the normalized counts. As such, a degree or amount of expertise or experience of an entity may be inferred from its entity activity data entries.

In some embodiments, the term “historical query response interaction” refers to a data construct that describes a past interaction of a user with a search result generated in response to a search query provided by the user. A historical query response interaction may comprise a recorded selection or click event with respect to a search result item (e.g., a link) on a search results page generated in response to a prior search query. In some embodiments, historical query response interactions of users may be used to generate time-stamped directed graphs of the users for training a transformer machine learning model to map search queries to one or more categorical identifiers.

In some embodiments, the term “user activity data entry” refers to a data construct that describes a bill of sale, receipt, or confirmation associated with an activity between a user and an entity. The activity may comprise a transaction or interaction and one or more categorical identifiers or associated categorical descriptions describing goods or services provided by an entity to a user at a specific date/time and location (e.g., entity locale). In one example embodiment, a user activity data entry comprises claims data including information such as, diagnoses, procedures, or treatments (e.g., in the form of ICD and/or CPT codes) performed by a healthcare provider (entity) on a user. In some embodiments, a user activity data entry may also comprise a user locale from which a user traveled to commence in an activity with an entity at an entity locale. In some embodiments, a user locale of a user may be determined from a user activity data entry associated with the user and a distance preference may be determined for the user based on the user locale. According to various embodiments of the present disclosure, user activity data entries may be used to generate time-stamped directed graphs of the users for training a transformer machine learning model to map search queries to one or more categorical identifiers.

In some embodiments, the term “transformer machine learning model” refers to a data construct that describes parameters, hyperparameters, and/or defined operations of a machine learning model that is configured to (i) generate one or more search query embeddings based on one or more search queries, (ii) generate one or more categorical description embeddings based on one or more categorical descriptions, (iii) match the one or more search queries to the one or more categorical descriptions based on a comparison of the one or more search query embeddings associated with respective ones of the one or more search queries with the one or more categorical description embeddings associated with respective ones of the one or more categorical descriptions, and (iv) determine one or more categorical identifiers for the one or more search queries based on the matching of the one or more search queries to one or more categorical descriptions associated with the one or more categorical identifiers. For example, a transformer machine learning model may receive a search query as input and generate an output comprising one or more categorical identifiers that are most relevant or similar (e.g., semantically) to the search query. In some embodiments, matching the one or more search queries to the one or more categorical descriptions further comprises determining a cosine similarity or a K-nearest neighbor between the one or more search query embeddings and the one or more categorical description embeddings. In some embodiments, the transformer machine learning model comprises a universal sentence encoder. In some embodiments, the transformer machine learning model comprises an N-layer sentence/word textual transformer machine learning model. In some embodiments, the transformer machine learning model comprises one or more (N-1)^{th} layers configured to encode search queries and one or more categorical descriptions. In some embodiments, the transformer machine learning model comprises a last layer N+1 configured to classify one or more search queries with respect to one or more categorical identifiers.

In some embodiments, the term “time-stamped directed graph” refers to a data construct that describes activities associated with a user. In some embodiments, a time-stamped directed graph comprises one or more temporally associated nodes, where each of the temporally associated nodes comprises either (i) a historical query response interaction associated with the user, or (ii) a user activity data entry comprising a confirming action (e.g., a visit) of the user with an entity. A temporally associated node may also comprise a date or time clement providing a temporal context for the temporally associated node. According to various embodiments of the present disclosure, one or more categorical descriptions may be inferred for one or more search queries of a user based on information in a time-stamped directed graph associated with the user. For example, information from a time-stamped directed graph comprising a historical query response interaction related to an entity and a user activity data entry related to the same entity within a given time window may be used to infer that a search associated with the historical query response interaction is related to the entity as well as one or more categorical identifiers from the user activity data entry related to the entity. Inferences drawn from a time-stamped directed graph may be used to train a transformer machine learning model to associate search queries with one or more categorical descriptions. In one example embodiment, a transformer machine learning model may observe a 3-month time window following a click event (historical query response interaction) associated with a search query, that a claim (user activity data entry) was received from a provider (entity) with an ICD code (categorical identifier) and the ICD code description (categorical description). Based on the observation, the transformer machine learning model may generate weights and parameters for encoding and classifying search queries to categorical identifiers.

### IV. Overview

Various embodiments of the present disclosure make important technical contributions to improving predictive accuracy of predictive machine learning models used in generating search results for search queries by generating search query embeddings based on inferred associations from past user activities. In some embodiments, the inferred associations are based on historical query response interactions and activity data entries. This approach improves training speed and training efficiency of training predictive machine learning models. It is well-understood in the relevant art that there is typically a tradeoff between predictive accuracy and training speed, such that it is trivial to improve training speed by reducing predictive accuracy. Thus, the challenge is to improve training speed without sacrificing predictive accuracy through innovative model architectures. Accordingly, techniques that improve predictive accuracy without harming training speed, such as the techniques described herein, enable improving training speed given a constant predictive accuracy. In doing so, the techniques described herein improve efficiency and speed of training predictive machine learning models, thus reducing the number of computational operations needed and/or the amount of training data entries needed to train predictive machine learning models. Accordingly, the techniques described herein improve the computational efficiency, storage-wise efficiency, and/or speed of training machine learning models.

For example, various embodiments of the present disclosure improve predictive accuracy of predictive machine learning models by generating search query embeddings based on inferred associations from past user activities. As described herein, users who enter search queries into a search retrieval system often want to receive the most relevant search results pertaining to the intent of their search queries. For example, users searching for a healthcare provider often look for someone who may quickly understand their conditions and has a great deal of experience diagnosing patients with similar conditions. However, distance may be a major factor in determining relevancy of search results (e.g., how far a customer is willing to travel to get treatment). That is, a user may consider traveling 50 miles to visit an oncologist but would want an obstetrician-gynecologist or primary care physician to be in a close vicinity of their home.

In some embodiments, the present disclosure enables an information retrieval system to dynamically expand or vary a search radius based on user preferences between distance and categorical identifiers. As such, retrieval criteria and an amount of relevant results may be varied by distance to account for a subject of a search query, thus improving the accuracy and performance of information retrieval systems.

Furthermore, entity description data that is available to a search retrieval system may lack fine-grained description of services a given entity may offer. For example, an entity tagged with a specialty of “internal medicine” doesn't convey much about diagnoses or treatments the entity may offer. Solving for such problems require a deeper understanding of the kinds of services an entity may offer, their level of familiarity with a condition, and understanding user preferences.

In accordance with various embodiments of the present disclosure, a transformer machine learning model may be trained to map search queries to categorical descriptions based on a user's historical query response interactions and activity data entries comprising one or more confirming actions of the user. This technique improves textual embeddings of search queries, leading to higher accuracy of performing predictive operations as needed on generating responses to the search queries. In doing so, the techniques described herein improve efficiency and speed of training predictive machine learning models, thus reducing the number of computational operations needed and/or the amount of training data entries needed to train predictive machine learning models. Accordingly, the techniques described herein improve the computational efficiency, storage-wise efficiency, and/or speed of training predictive machine learning models. Other technical improvements and advantages may be realized by one of ordinary skill in the art.

### V. Example System Operations

As indicated, various embodiments of the present disclosure make important technical contributions to improving predictive accuracy of predictive machine learning models used in generating search results for search queries by generating search query embeddings based on inferred associations from past user activities. In some embodiments, the inferred associations are based on historical query response interactions and activity data entries. This approach improves training speed and training efficiency of training predictive machine learning models. It is well-understood in the relevant art that there is typically a tradeoff between predictive accuracy and training speed, such that it is trivial to improve training speed by reducing predictive accuracy. Thus, the challenge is to improve training speed without sacrificing predictive accuracy through innovative model architectures. Accordingly, techniques that improve predictive accuracy without harming training speed, such as the techniques described herein, enable improving training speed given a constant predictive accuracy. In doing so, the techniques described herein improve efficiency and speed of training predictive machine learning models, thus reducing the number of computational operations needed and/or the amount of training data entries needed to train predictive machine learning models. Accordingly, the techniques described herein improve the computational efficiency, storage-wise efficiency, and/or speed of training machine learning models.

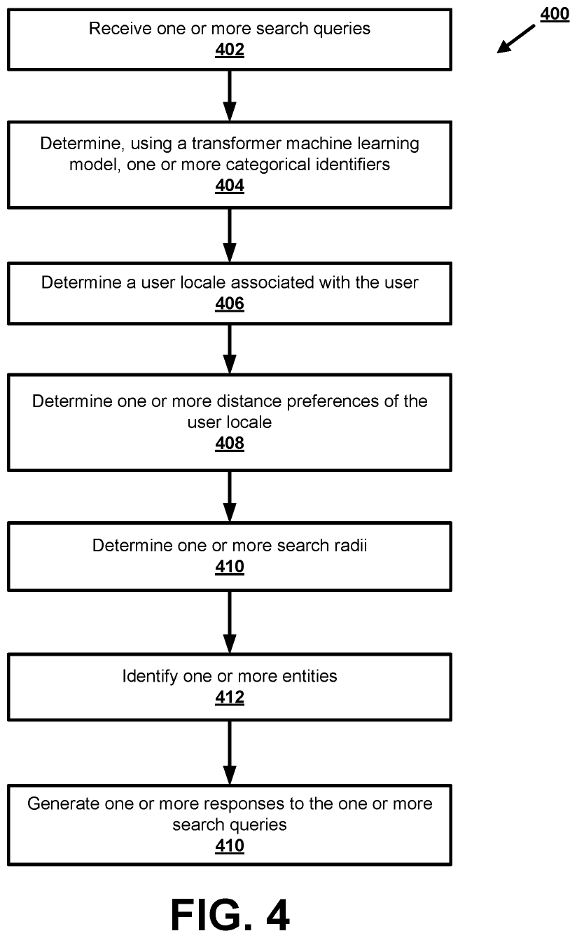

FIG. 4 is a flowchart diagram of an example process 400 for retrieving search results for search queries in accordance with some embodiments of the present disclosure.

In some embodiments, via the various steps/operations of the process 400, the predictive data analysis computing entity 106 may use a transformer machine learning model to match a search query to one or more categorical identifiers, determine distances one or more preferences of a user locale associated with a user providing the search query, and generate one or more responses to the search query comprising one or more entities identified based on the one or more distance preferences and the one or more categorical identifiers.

In some embodiments, the process 400 begins at step/operation 402 when the predictive data analysis computing entity 106 receives one or more search queries from a user. In some embodiments, a search query describes a request for information. A search query may comprise one or more keywords, phrases, characters, numbers, symbols, or any combination thereof. According to various embodiments of the present disclosure, search queries may be received by predictive data analysis system 101 and/or predictive data analysis computing entity 106 from one or more client computing entities 102, either directly or indirectly via, e.g., an information retrieval system comprising a search engine.

In some embodiments, at step/operation 404, the predictive data analysis computing entity 106 determines, using a transformer machine learning model, one or more categorical identifiers for the one or more search queries based on one or more matches of the one or more search queries to one or more categorical descriptions associated with the one or more categorical identifiers.

In some embodiments, a categorical identifier describes a sequence of characters, numbers, symbols, or any combination thereof associated with a categorical description. The determined one or more categorical identifiers may comprise categorical identifiers that are similar to the one or more search queries based on one or more matches of one or more categorical descriptions associated with the one or more categorical identifiers to the one or more search queries. For example, categorical identifiers may comprise diagnostic codes (e.g., International Classification of Diseases (ICD) or Current Procedural Terminology (CPT) codes) associated with diagnoses or treatments healthcare providers may perform.

In some embodiments, a categorical description describes one or more keywords, phrases, or numbers, associated with a classification according to a given taxonomy. One or more categorical descriptions may be associated with an entity to describe one or more goods or services provided by the entity. According to various embodiments of the present disclosure, one or more search queries may be matched to one or more categorical descriptions, and based on the matching, one or more categorical identifiers may be determined and used to identify one or more entities for responding to the one or more search queries. In one example embodiment, a categorical description may comprise a description of diagnostic codes (e.g., International Classification of Diseases (ICD) or Current Procedural Terminology (CPT) codes) associated with diagnoses or treatments healthcare providers may perform.

In some embodiments, a transformer machine learning model describes parameters, hyperparameters, and/or defined operations of a machine learning model that is configured to receive a search query as input and generate an output comprising one or more categorical identifiers that are most relevant or similar (e.g., semantically) to the search query. In some embodiments, matching the one or more search queries to the one or more categorical descriptions further comprises determining a cosine similarity or a K-nearest neighbor between a search query embedding of the search query and one or more categorical description embeddings of the categorical description embeddings. In some embodiments, the transformer machine learning model comprises a universal sentence encoder. In some embodiments, the transformer machine learning model comprises an N-layer sentence/word textual transformer machine learning model. In some embodiments, the transformer machine learning model comprises one or more (N−1)^{th} layers configured to encode search queries and one or more categorical descriptions. In some embodiments, the transformer machine learning model comprises a last layer N+1 configured to classify one or more search queries with respect to one or more categorical identifiers.

According to various embodiments of the present disclosure, historical query response interactions and user activity data entries may be used to generate time-stamped directed graphs for training a transformer machine learning model to map search queries to one or more categorical identifiers. In some embodiments, a historical query response interaction describes a past interaction of a user with a search result generated in response to a search query provided by the user. A historical query response interaction may comprise a recorded selection or click event with respect to a search result item (e.g., a link) on a search results page generated in response to a prior search query.

In some embodiments, a user activity data entry describes a bill of sale, receipt, or confirmation associated with an activity between a user and an entity. The activity may comprise a transaction or interaction and associated one or more categorical identifiers or categorical descriptions describing goods or services provided by an entity to a user at a specific date/time and location (e.g., entity locale). In some embodiments, a user activity data entry may also comprise a user locale from which a user traveled to commence in an activity with an entity at an entity locale. In one example embodiment, a user activity data entry comprises claims data including information such as, diagnoses, procedures, or treatments (e.g., in the form of ICD and/or CPT codes) performed by a healthcare provider (entity) on a user. In some embodiments, an entity locale refers to a locale of an entity. For example, an entity locale associated with an entity may comprise a zip code of the entity.

In some embodiments, a time-stamped directed graph describes activities associated with a user. In some embodiments, a time-stamped directed graph comprises one or more temporally associated nodes, where each of the temporally associated nodes comprises either (i) a historical query response interaction associated with the user, or (ii) a user activity data entry comprising a confirming action (e.g., a visit) of the user with an entity. A temporally associated node may also comprise a date or time element providing a temporal context for the temporally associated node. According to various embodiments of the present disclosure, one or more categorical descriptions may be inferred for one or more search queries of a user based on information in a time-stamped directed graph associated with the user. For example, information from a time-stamped directed graph comprising a historical query response interaction related to an entity and a user activity data entry related to the same entity within a given time window may be used to infer that a search associated with the historical query response interaction is related to the entity as well as one or more categorical identifiers from the user activity data entry related to the entity. Inferences drawn from a time-stamped directed graph may be used to train a transformer machine learning model to associate search queries with one or more categorical descriptions. In one example embodiment, a transformer machine learning model may observe a 3-month time window following a click event (historical query response interaction) associated with a search query, that a claim (user activity data entry) was received from a provider (entity) with an ICD code (categorical identifier) and the ICD code description (categorical description). Based on the observation, the transformer machine learning model may generate weights and parameters for encoding and classifying search queries to categorical identifiers.

As described herein, in accordance with various embodiments of the present disclosure, a transformer machine learning model may be trained to map search queries to categorical descriptions based on a user's historical query response interactions and activity data entries comprising one or more confirming actions of the user. This technique will improve textual embeddings of search queries, leading to higher accuracy of performing predictive operations as needed on generating responses to the search queries. In doing so, the techniques described herein improve efficiency and speed of training predictive machine learning models, thus reducing the number of computational operations needed and/or the amount of training data entries needed to train predictive machine learning models. Accordingly, the techniques described herein improve the computational efficiency, storage-wise efficiency, and/or speed of training predictive machine learning models. In further embodiments, an information retrieval system may dynamically expand or vary a search radius based on user preferences between distance and categorical identifiers. As such, retrieval criteria and an amount of relevant results may be varied by distance to account for a subject of a search query, thus improving the accuracy and performance of information retrieval systems.

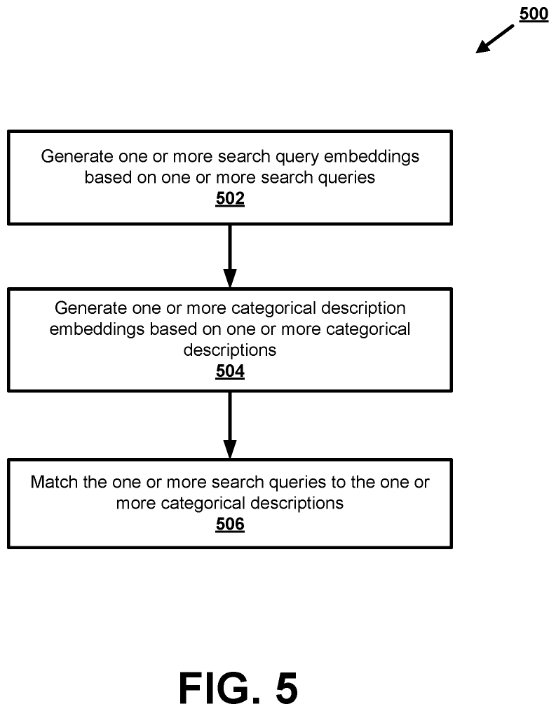

Additional details of data analysis computing entity 106 determining one or more categorical identifiers, at step/operation 404, is described in further detail with respect to the description of FIG. 5.

In some embodiments, at step/operation 406, the predictive data analysis computing entity 106 determines a user locale associated with the user. In some embodiments, a locale describes a geographic location, place, or region. A user locale refers to a locale of a user. In one example embodiment, the user locale associated with the user comprises a zip code of the user. In some embodiments, the user locale may be determined based on user activity data entries associated with the user. For example, a user locale of a user may be extracted from one or more user activity data entries comprising an address of the user.

In some embodiments, at step/operation 408, the predictive data analysis computing entity 106 determines one or more distance preferences of the user locale based on one or more mappings of the one or more categorical identifiers to one or more statistical distances associated with the user locale. In particular, distance preferences of users in certain locales for specific categorical identifiers may be determined by mapping categorical identifiers to respective statistical distances associated with user locales based on entity activity data entries associated with the users.

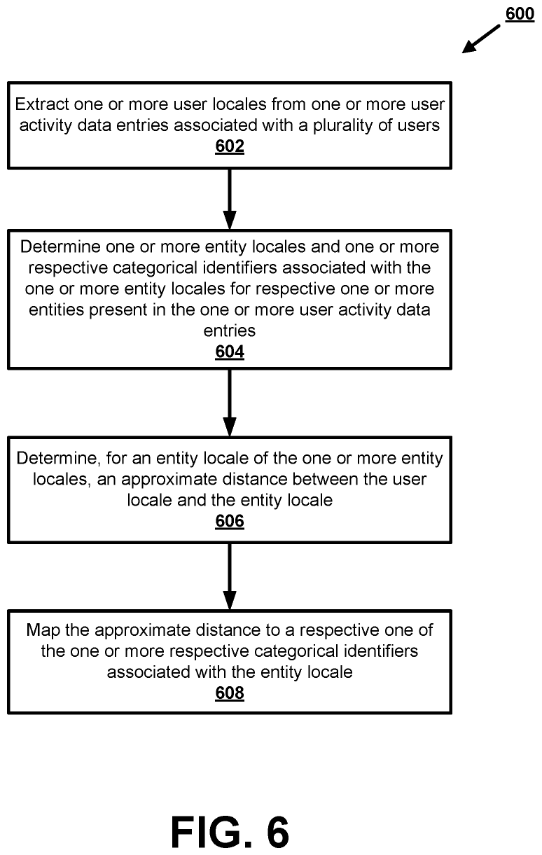

In some embodiments, a distance preference describes a propensity or inclination of users associated with a given locale selecting (e.g., either via a historical query response interaction or a user activity data entry) search results comprising entities comprising entity locales that are within a certain distance from the given locale. For example, a distance preference may comprise a distance that a typical user of a certain user locale is willing to travel to obtain particular goods or services. A distance preference for a user locale may be determined based on a mapping of one or more categorical identifiers to one or more statistical distances associated with the user locale. Mapping one or more categorical identifiers to one or more statistical distances is described in further detail with respect to the description of FIG. 6.

In some embodiments, a statistical distance describes a representative distance between a plurality of locales, such as between a user locale and an entity locale. According to various embodiments of the present disclose, a statistical distance comprises an aggregate distance calculated (e.g., average, median, or mode) between a particular user locale and an entity locale based on a plurality of user activity data entries comprising a plurality of users associated with the user locale and one or more entities associated with respective one or more entity locales. As such, the statistical distance may comprise a typical distance between a user of a certain user locale and an entity of a certain entity locale the user will interact with (e.g., visit).

In some embodiments, at step/operation 410, the predictive data analysis computing entity 106 determines one or more search radii based on the one or more distance preferences and the one or more categorical identifiers. That is, the predictive data analysis computing entity 106 may determine a search radius for each of the one or more search queries that is specific to the user's locale and categorical identifiers of the one or more search queries. In some embodiments, a search radius describes a search parameter associated with a distance of one or more entities, e.g., associated with one or more search results for a search query, from a user locale of a user providing the search query. For example, a search radius for a given search query may be determined or modified for a user's search query based on a user locale (e.g., zip code) of the user and one or more categorical identifiers (e.g., best 3-character ICD code(s)) matched to the given search query.

In some embodiments, at step/operation 412, the predictive data analysis computing entity 106 identifies one or more entities based on (i) one or more entity activity data entries associated with the one or more entities that match the one or more categorical identifiers and (ii) the one or more search radii. The search radius determined for the search query may be used to identify one or more entities in response to the search query by retrieving entities within the search radius comprising entity activity data entries associated with one or more categorical identifiers matching the search query.

In some embodiments, an entity describes a data object, article, file, program, service, task, operation, computing entity, and/or the like unit comprising a source of goods or services. For example, an entity may comprise a healthcare provider that may be identified and retrieved in response to search queries. In some embodiments, a user may provide a search query from a client computing entity 102 to predictive data analysis computing entity 106 either directly, or via an information retrieval system comprising a search engine, and in response to the search query, one or more entities may be identified and returned to the client computing entity 106, e.g., as search results for the search query.

In some embodiments, an entity activity data entry describes a bill of sale, receipt, or confirmation associated with an activity between an entity and a user. The activity may comprise a transaction or interaction and one or more categorical identifiers or categorical descriptions describing goods or services provided by an entity to a user at a specific date/time and location (e.g., entity locale). In some embodiments, an entity activity data entry may comprise claims data including information such as, diagnoses, procedures, or treatments (e.g., in the form of ICD and/or CPT codes) performed by a healthcare provider (entity) on a user. In some embodiments, an entity activity data entry may also comprise an entity locale at which an entity commenced in an activity with a user.

According to various embodiments of the present disclosure, entity activity data entries may be analyzed and used to identify one or more entities for generating a response to a search query. In some embodiments, for each of one or more entities within a search radius, an entity may be identified based on one or more entity activity data entries associated with the one or more entities matching one or more categorical identifiers matching the search query.

In some embodiments, at step/operation 414, the predictive data analysis computing entity 106 generates one or more responses to the one or more search queries based on the one or more entities. In some embodiments, generating the one or more responses further comprises determining counts of entity activity data entries that match the one or more categorical identifiers within a time window and ranking the one or more entities based on the determined counts. The counts may be normalized, and the one or more entities may be sorted and ranked for relevancy to the search query based on the normalized counts. As such, a degree or amount of expertise or experience of an entity may be inferred from its entity activity data entries.

In some embodiments, if no entities are identified at step/operation 412, an alternative search algorithm may be used to generate one or more responses that relies on user query to taxonomy matching (e.g., provider NUCC) to return results. In some embodiments, the one or more responses may be generated based on additional ranking factors, for example, business factors such as average cost (e.g., of care for a provider), distance from a user, entity ratings, user factors, or click-through rate. Ranking factors may be used individually or be combined in a weighted manner.

In one example embodiment, via the various steps/operations of the process 400, the predictive data analysis computing entity 106 receives a search query comprising “hair loss problem” from a user (e.g., via a client computing entity 102). The user may be associated with a user locale comprising a zip code of 94104. The search query may be mapped to a categorical identifier comprising “L63” associated with alopecia areata (a categorical description) and expanded to a 15-mile search radius based on the user locale. The search query may be represented as “94104: L63: 15 miles” and one or more providers within the search radius and having entity activity data entries associated with categorical identifier may be retrieved. The retrieved one or more providers may be ranked in order of normalized matching entity activity data entries counts (e.g., [Provider A: L63: 82], [Provider B: L63: 100] . . . ).

FIG. 5 is a flowchart diagram of an example process for determining categorical identifiers for search queries in accordance with some embodiments of the present disclosure. In some embodiments, the process 500 begins at step/operation 502 when the predictive data analysis computing entity 106 generates one or more search query embeddings based on one or more search queries.

In some embodiments, an embedding describes a latent representation of data comprising one or more features. For example, an embedding of data may be expressed as a vector comprising one or more numbers representative of one or more features associated with content of the data. In some embodiments, an embedding may be generated by mapping one or more features to one or more elements in a vector space. According to various embodiments of the present disclosure, an embedding comprises a feature associated with machine learning model input data. One or more embeddings may be generated for machine learning model input data such that the machine learning model input data may be provided in a format suitable for analysis or processing by a machine learning model.

In some embodiments, a search query embedding refers to an embedding of a search query. That is, a search query embedding may comprise a latent representation of a search query and may be expressed as a vector comprising one or more numbers representative of one or more features associated with the search query. In some embodiments, a search query embedding may be generated by a transformer machine learning model.

In some embodiments, at step/operation 504, the predictive data analysis computing entity 106 generates one or more categorical description embeddings based on one or more categorical descriptions.

In some embodiments, a categorical description refers to a data construct that describes one or more keywords, numbers, or phrases associated with a classification according to a given taxonomy. One or more categorical descriptions may be associated with an entity to describe one or more goods or services provided by the entity. According to various embodiments of the present disclosure, one or more search queries may be matched to one or more categorical descriptions, and based on the matching, one or more categorical identifiers may be determined and used to identify one or more entities for responding to the one or more search queries. In one example embodiment, a categorical description may comprise a description of diagnostic codes (e.g., International Classification of Diseases (ICD) or Current Procedural Terminology (CPT) codes) associated with diagnoses or treatments healthcare providers may perform.

In some embodiments, a categorical description embedding refers to an embedding of a categorical description. That is, a categorical description embedding may comprise a latent representation of a categorical description and may be expressed as a vector comprising one or more numbers representative of one or more features associated with the categorical description. In some embodiments, a categorical description embedding may be generated by a transformer machine learning model.

In some embodiments, at step/operation 506, the predictive data analysis computing entity 106 matches the one or more search queries to the one or more categorical descriptions based on a comparison of the one or more search query embeddings associated with respective ones of the one or more search queries with the one or more categorical description embeddings associated with respective ones of the one or more categorical descriptions. In some embodiments, the one or more search query embeddings and the one or more categorical description embeddings are generated such that semantic matching of search queries to categorical descriptions may be performed. Semantic matching of a search query to one or more categorical descriptions may be performed based on a comparison, e.g., using a transformer machine learning model, between a search query embedding associated with a search query and one or more categorical description embeddings associated with respective ones of the one or more categorical descriptions. In some embodiments, matching the one or more search queries to the one or more categorical descriptions further comprises determining a cosine similarity or a K-nearest neighbor between the one or more search query embeddings and the one or more categorical description embeddings.

FIG. 6 is a flowchart diagram of an example process 600 for mapping categorical identifiers to statistical distances in accordance with some embodiments of the present disclosure. A machine learning model may be trained on a relationship between the distance a user is willing to travel with respect to goods or services provided by an entity. According to various embodiments of the present disclosure, user activity data entries are utilized to create mappings of average distances travelled by users of certain locales to entities. In some embodiments, a mapping for each of a plurality of user locales may be generated for each of one or more categorical identifiers to a statistical distance based on a plurality of user activity data entries associated with a plurality of users belonging to the plurality of user locales.

In one example embodiment, via the various steps/operations of the process 600, the predictive data analysis computing entity 106 generates, per user zip code and across all claims data, mappings of categorical identifiers to average distance travelled by users to an entity. For example, a zip code of “94104” may be associated with mappings comprising a three-digit ICD code “Q321” (e.g., a high-level ICD code) mapped to 3 miles and a three-digit ICD code “A123” mapped to 17 miles.

In some embodiments, the process 600 begins at step/operation 602 when the predictive data analysis computing entity 106 extracts one or more user locales from one or more user activity data entries associated with a plurality of users. For example, for each of the plurality of users, a user zip code location zᵤ may be extracted from claims data associated with the user.

In some embodiments, at step/operation 604, the predictive data analysis computing entity 106 determines one or more entity locales and one or more respective categorical identifiers associated with the one or more entity locales for respective one or more entities present in the one or more user activity data entries. For example, for each of one or more claims data received by a user from a provider (entity) during a visit, a provider zip code zₚ and a 3-character ICD code i may be identified.

In some embodiments, at step/operation 606, the predictive data analysis computing entity 106 determines, for an entity locale of the one or more entity locales, an approximate distance between the user locale and the entity locale (e.g., between user zip code location zᵤ and provider zip code zₚ).

In some embodiments, at step/operation 608, the predictive data analysis computing entity 106 maps the approximate distance to a respective one of the one or more respective categorical identifiers associated with the entity locale (e.g., map approximate distance between zᵤ and zₚ to ICD code i).

Accordingly, as described above, various embodiments of the present disclosure make important technical contributions to improving predictive accuracy of predictive machine learning models used in generating search results for search queries by generating search query embeddings based on inferred associations from past user activities. In some embodiments, the inferred associations are based on historical query response interactions and activity data entries. This approach improves training speed and training efficiency of training predictive machine learning models. It is well-understood in the relevant art that there is typically a tradeoff between predictive accuracy and training speed, such that it is trivial to improve training speed by reducing predictive accuracy. Thus, the challenge is to improve training speed without sacrificing predictive accuracy through innovative model architectures. Accordingly, techniques that improve predictive accuracy without harming training speed, such as the techniques described herein, enable improving training speed given a constant predictive accuracy. In doing so, the techniques described herein improve efficiency and speed of training predictive machine learning models, thus reducing the number of computational operations needed and/or the amount of training data entries needed to train predictive machine learning models. Accordingly, the techniques described herein improve the computational efficiency, storage-wise efficiency, and/or speed of training machine learning models.

Some techniques of the present disclosure enable the generation of entities that may be used to generate responses to search queries. The techniques of the present disclosure may be used, applied, and/or otherwise leveraged to generate a transformer machine learning model to determine categorical identifiers for search queries. The transformer machine learning model of the present disclosure may be leveraged to generate responses to search queries that improve the performance of a computing system (e.g., a computer itself, etc.) with respect to various predictive actions performed by the predictive data analysis computing entity 106, such as for the matching of search queries to categorical descriptions associated with the categorical identifiers, and/or the like.

In some examples, the responses to search queries may include predictive actions that may be based on a prediction domain. A prediction domain may include any environment in which computing systems may be applied to achieve real-word insights, such as predictions (e.g., abstractive summaries, predictive intents, etc.), and initiate the performance of computing tasks, such as predictive actions e.g., updating user preferences, providing account information, cancelling an account, adding an account, etc.) to act on the real-world insights. These predictive actions may cause real-world changes, for example, by controlling a hardware component, providing alerts, interactive actions, and/or the like.

Examples of prediction domains may include financial systems, clinical systems, autonomous systems, robotic systems, and/or the like. Predictive actions in such domains may include the initiation of automated instructions across and between devices, automated notifications, automated scheduling operations, automated precautionary actions, automated security actions, automated data processing actions, automated data compliance actions, automated data access enforcement actions, automated adjustments to computing and/or human data access management, and/or the like.

### VI. Conclusion

Many modifications and other embodiments will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

### VII. EXAMPLES

Example 1. A computer-implemented method comprising: receiving, by one or more processors, one or more search queries from a user; determining, by the one or more processors and using a transformer machine learning model, one or more categorical identifiers for the one or more search queries based on one or more matches of the one or more search queries to one or more categorical descriptions associated with the one or more categorical identifiers; determining, by the one or more processors, a user locale associated with the user; determining, by the one or more processors, one or more distance preferences of the user locale based on one or more mappings of the one or more categorical identifiers to one or more statistical distances associated with the user locale; determining, by the one or more processors, one or more search radii based on the one or more distance preferences and the one or more categorical identifiers; identifying, by the one or more processors, one or more entities based on (i) one or more entity activity data entries associated with the one or more entities that match the one or more categorical identifiers and (ii) the one or more search radii; and generating, by the one or more processors, one or more responses to the one or more search queries based on the one or more entities.

Example 2. The computer-implemented method of any of the preceding examples, wherein the transformer machine learning model comprises a universal sentence encoder.

Example 3. The computer-implemented method of any of the preceding examples, wherein the transformer machine learning model comprises an N-layer sentence/word textual transformer machine learning model.

Example 4. The computer-implemented method of any of the preceding examples, wherein the transformer machine learning model comprises a last layer N+1 configured to classify the one or more search queries with respect to the one or more categorical identifiers.

Example 5. The computer-implemented method of any of the preceding examples, wherein the transformer machine learning model comprises one or more (N−1)^{th} layers configured to encode the one or more search queries and the respective ones of the one or more categorical descriptions.

Example 6. The computer-implemented method of any of the preceding examples, wherein determining the one or more categorical identifiers further comprises: generating one or more search query embeddings based on the one or more search queries; generating one or more categorical description embeddings based on the one or more categorical descriptions; and matching the one or more search queries to the one or more categorical descriptions based on a comparison of the one or more search query embeddings associated with respective ones of the one or more search queries with the one or more categorical description embeddings associated with respective ones of the one or more categorical descriptions.

Example 7. The computer-implemented method of any of the preceding examples, wherein matching the one or more search queries to the one or more categorical descriptions further comprises determining a cosine similarity or a K-nearest neighbor between the one or more search query embeddings and the one or more categorical description embeddings.

Example 8. The computer-implemented method of any of the preceding examples further comprising training the transformer machine learning model based on one or more time-stamped directed graphs associated with the user, wherein one of the one or more time-stamped directed graphs comprises (i) one or more historical query response interactions associated with the user and (ii) one or more user activity data entries comprising one or more confirming actions of the user.

Example 10. The computer-implemented method of any of the preceding examples, wherein the one or more historical query response interactions comprises one or more selections of one or more search results associated with one or more prior search queries from the user.

Example 11. The computer-implemented method of any of the preceding examples, wherein the one or more historical query response interactions and the one or more user activity data entries have occurred with an observation time-window.

Example 12. The computer-implemented method of any of the preceding examples further comprising determining the one or more statistical distances based on an average distance between a plurality of user locales associated with a plurality of aggregate users and a plurality of entity locales.

Example 13. The computer-implemented method of any of the preceding examples further comprising ranking the one or more entities based on amount of the one or more entity activity data entries matching the one or more categorical identifiers.

Example 14. The computer-implemented method of any of the preceding examples further comprising generating the one or more mappings by: extracting one or more user locales from one or more user activity data entries associated with a plurality of users; determining one or more entity locales and one or more respective categorical identifiers associated with the one or more entity locales for respective one or more entities present in the one or more user activity data entries; determining, for an entity locale of the one or more entity locales, an approximate distance between the user locale and the entity locale; and mapping the approximate distance to a respective one of the one or more respective categorical identifiers associated with the entity locale.

Example 15. A computing system comprising memory and one or more processors communicatively coupled to the memory, the one or more processors configured to: receive one or more search queries from a user; determine, using a transformer machine learning model, one or more categorical identifiers for the one or more search queries based on one or more matches of the one or more search queries to one or more categorical descriptions associated with the one or more categorical identifiers; determine a user locale associated with the user; determine one or more distance preferences of the user locale based on one or more mappings of the one or more categorical identifiers to one or more statistical distances associated with the user locale; determine one or more search radii based on the one or more distance preferences and the one or more categorical identifiers; identify one or more entities based on (i) one or more entity activity data entries associated with the one or more entities that match the one or more categorical identifiers and (ii) the one or more search radii; and generate one or more responses to the one or more search queries based on the one or more entities.

Example 16. The computing system of any of the preceding examples, wherein the transformer machine learning model comprises a universal sentence encoder.

Example 17. The computing system of any of the preceding examples, wherein the transformer machine learning model comprises an N-layer sentence/word textual transformer machine learning model.

Example 18. The computing system of any of the preceding examples, wherein the transformer machine learning model comprises a last layer N+1 configured to classify the one or more search queries with respect to the one or more categorical identifiers.

Example 19. The computing system of any of the preceding examples, wherein the transformer machine learning model comprises one or more (N−1)^{th} layers configured to encode the one or more search queries and the respective ones of the one or more categorical descriptions.

Example 20. The computing system of any of the preceding examples, wherein the one or more processors are further configured to determine the one or more categorical identifiers by: generating one or more search query embeddings based on the one or more search queries; generating one or more categorical description embeddings based on the one or more categorical descriptions; and matching the one or more search queries to the one or more categorical descriptions based on a comparison of the one or more search query embeddings associated with respective ones of the one or more search queries with the one or more categorical description embeddings associated with respective ones of the one or more categorical descriptions.

Example 21. The computing system of any of the preceding examples, wherein the one or more processors are further configured to match the one or more search queries to the one or more categorical descriptions by determining a cosine similarity or a K-nearest neighbor between the one or more search query embeddings and the one or more categorical description embeddings.

Example 22. The computing system of any of the preceding examples, wherein the one or more processors are further configured to train the transformer machine learning model based on one or more time-stamped directed graphs associated with the user, wherein one of the one or more time-stamped directed graphs comprises (i) one or more historical query response interactions associated with the user and (ii) one or more user activity data entries comprising one or more confirming actions of the user.

Example 23. The computing system of any of the preceding examples, wherein the one or more historical query response interactions comprises one or more selections of one or more search results associated with one or more prior search queries from the user.

Example 24. The computing system of any of the preceding examples, wherein the one or more historical query response interactions and the one or more user activity data entries have occurred with an observation time-window.

Example 25. The computing system of any of the preceding examples, wherein the one or more processors are further configured to determine the one or more statistical distances based on an average distance between a plurality of user locales associated with a plurality of aggregate users and a plurality of entity locales.

Example 26. The computing system of any of the preceding examples, wherein the one or more processors are further configured to rank the one or more entities based on amount of the one or more entity activity data entries matching the one or more categorical identifiers.

Example 27. The computing system of any of the preceding examples, wherein the one or more processors are further configured to generate the one or more mappings by: extracting one or more user locales from one or more user activity data entries associated with a plurality of users; determining one or more entity locales and one or more respective categorical identifiers associated with the one or more entity locales for respective one or more entities present in the one or more user activity data entries; determining, for an entity locale of the one or more entity locales, an approximate distance between the user locale and the entity locale; and mapping the approximate distance to a respective one of the one or more respective categorical identifiers associated with the entity locale.

Example 28. One or more non-transitory computer-readable storage media including instructions that, when executed by one or more processors, cause the one or more processors to: receive one or more search queries from a user; determine, using a transformer machine learning model, one or more categorical identifiers for the one or more search queries based on one or more matches of the one or more search queries to one or more categorical descriptions associated with the one or more categorical identifiers; determine a user locale associated with the user; determine one or more distance preferences of the user locale based on one or more mappings of the one or more categorical identifiers to one or more statistical distances associated with the user locale; determine one or more search radii based on the one or more distance preferences and the one or more categorical identifiers; identify one or more entities based on (i) one or more entity activity data entries associated with the one or more entities that match the one or more categorical identifiers and (ii) the one or more search radii; and generate one or more responses to the one or more search queries based on the one or more entities.

Example 29. The one or more non-transitory computer-readable storage media of any of the preceding examples, wherein the transformer machine learning model comprises a universal sentence encoder.

Example 30. The one or more non-transitory computer-readable storage media of any of the preceding examples, wherein the transformer machine learning model comprises an N-layer sentence/word textual transformer machine learning model.

Example 31. The one or more non-transitory computer-readable storage media of any of the preceding examples, wherein the transformer machine learning model comprises a last layer N+1 configured to classify the one or more search queries with respect to the one or more categorical identifiers.

Example 32. The one or more non-transitory computer-readable storage media of any of the preceding examples, wherein the transformer machine learning model comprises one or more (N−1)^{th} layers configured to encode the one or more search queries and the respective ones of the one or more categorical descriptions.

Example 33. The one or more non-transitory computer-readable storage media of any of the preceding examples further including instructions that, when executed by the one or more processors, cause the one or more processors to determine the one or more categorical identifiers by: generating one or more search query embeddings based on the one or more search queries; generating one or more categorical description embeddings based on the one or more categorical descriptions; and matching the one or more search queries to the one or more categorical descriptions based on a comparison of the one or more search query embeddings associated with respective ones of the one or more search queries with the one or more categorical description embeddings associated with respective ones of the one or more categorical descriptions.

Example 34. The one or more non-transitory computer-readable storage media of any of the preceding examples further including instructions that, when executed by the one or more processors, cause the one or more processors to match the one or more search queries to the one or more categorical descriptions by determining a cosine similarity or a K-nearest neighbor between the one or more search query embeddings and the one or more categorical description embeddings.

Example 35. The one or more non-transitory computer-readable storage media of any of the preceding examples further including instructions that, when executed by the one or more processors, cause the one or more processors to train the transformer machine learning model based on one or more time-stamped directed graphs associated with the user, wherein one of the one or more time-stamped directed graphs comprises (i) one or more historical query response interactions associated with the user and (ii) one or more user activity data entries comprising one or more confirming actions of the user.

Example 36. The one or more non-transitory computer-readable storage media of any of the preceding examples, wherein the one or more historical query response interactions comprises one or more selections of one or more search results associated with one or more prior search queries from the user.

Example 37. The one or more non-transitory computer-readable storage media of any of the preceding examples, wherein the one or more historical query response interactions and the one or more user activity data entries have occurred with an observation time-window.

Example 38. The one or more non-transitory computer-readable storage media of any of the preceding examples further including instructions that, when executed by the one or more processors, cause the one or more processors to determine the one or more statistical distances based on an average distance between a plurality of user locales associated with a plurality of aggregate users and a plurality of entity locales.

Example 39. The one or more non-transitory computer-readable storage media of any of the preceding examples further including instructions that, when executed by the one or more processors, cause the one or more processors to rank the one or more entities based on amount of the one or more entity activity data entries matching the one or more categorical identifiers.

Example 40. The one or more non-transitory computer-readable storage media of any of the preceding examples further including instructions that, when executed by the one or more processors, cause the one or more processors to generate the one or more mappings by: extracting one or more user locales from one or more user activity data entries associated with a plurality of users; determining one or more entity locales and one or more respective categorical identifiers associated with the one or more entity locales for respective one or more entities present in the one or more user activity data entries; determining, for an entity locale of the one or more entity locales, an approximate distance between the user locale and the entity locale; and mapping the approximate distance to a respective one of the one or more respective categorical identifiers associated with the entity locale.

1. A computer-implemented method comprising:
receiving, by one or more processors, one or more search queries from a user;
determining, by the one or more processors and using a transformer machine learning model, one or more categorical identifiers for the one or more search queries based on one or more matches of the one or more search queries to one or more categorical descriptions associated with the one or more categorical identifiers;
determining, by the one or more processors, a user locale associated with the user;
determining, by the one or more processors, one or more distance preferences of the user locale based on one or more mappings of the one or more categorical identifiers to one or more statistical distances associated with the user locale;
determining, by the one or more processors, one or more search radii based on the one or more distance preferences and the one or more categorical identifiers;
identifying, by the one or more processors, one or more entities based on (i) one or more entity activity data entries associated with the one or more entities that match the one or more categorical identifiers and (ii) the one or more search radii; and
generating, by the one or more processors, one or more responses to the one or more search queries based on the one or more entities.

2. The computer-implemented method of claim 1, wherein the transformer machine learning model comprises a universal sentence encoder.

3. The computer-implemented method of claim 1, wherein the transformer machine learning model comprises an N-layer sentence/word textual transformer machine learning model.

4. The computer-implemented method of claim 3, wherein the transformer machine learning model comprises a last layer N+1 configured to classify the one or more search queries with respect to the one or more categorical identifiers.

5. The computer-implemented method of claim 3, wherein the transformer machine learning model comprises one or more (N−1)^{th} layers configured to encode the one or more search queries and the respective ones of the one or more categorical descriptions.

6. The computer-implemented method of claim 1, wherein determining the one or more categorical identifiers further comprises:
generating one or more search query embeddings based on the one or more search queries;
generating one or more categorical description embeddings based on the one or more categorical descriptions; and
matching the one or more search queries to the one or more categorical descriptions based on a comparison of the one or more search query embeddings associated with respective ones of the one or more search queries with the one or more categorical description embeddings associated with respective ones of the one or more categorical descriptions.

7. The computer-implemented method of claim 6, wherein matching the one or more search queries to the one or more categorical descriptions further comprises determining a cosine similarity or a K-nearest neighbor between the one or more search query embeddings and the one or more categorical description embeddings.

8. The computer-implemented method of claim 1 further comprising training the transformer machine learning model based on one or more time-stamped directed graphs associated with the user, wherein one of the one or more time-stamped directed graphs comprises (i) one or more historical query response interactions associated with the user and (ii) one or more user activity data entries comprising one or more confirming actions of the user.

9. The computer-implemented method of claim 8, wherein the one or more historical query response interactions comprises one or more selections of one or more search results associated with one or more prior search queries from the user.

10. The computer-implemented method of claim 8, wherein the one or more historical query response interactions and the one or more user activity data entries have occurred with an observation time-window.

11. The computer-implemented method of claim 1 further comprising determining the one or more statistical distances based on an average distance between a plurality of user locales associated with a plurality of aggregate users and a plurality of entity locales.

12. The computer-implemented method of claim 1 further comprising determining the user locale based on one or more user activity data entries associated with the user.

13. The computer-implemented method of claim 1 further comprising ranking the one or more entities based on amount of the one or more entity activity data entries matching the one or more categorical identifiers.

14. The computer-implemented method of claim 1 further comprising generating the one or more mappings by:
extracting one or more user locales from one or more user activity data entries associated with a plurality of users;
determining one or more entity locales and one or more respective categorical identifiers associated with the one or more entity locales for respective one or more entities present in the one or more user activity data entries;
determining, for an entity locale of the one or more entity locales, an approximate distance between the user locale and the entity locale; and
mapping the approximate distance to a respective one of the one or more respective categorical identifiers associated with the entity locale.

15. A computing system comprising memory and one or more processors communicatively coupled to the memory, the one or more processors configured to:
receive one or more search queries from a user;
determine, using a transformer machine learning model, one or more categorical identifiers for the one or more search queries based on one or more matches of the one or more search queries to one or more categorical descriptions associated with the one or more categorical identifiers;
determine a user locale associated with the user;
determine one or more distance preferences of the user locale based on one or more mappings of the one or more categorical identifiers to one or more statistical distances associated with the user locale;
determine one or more search radii based on the one or more distance preferences and the one or more categorical identifiers;
identify one or more entities based on (i) one or more entity activity data entries associated with the one or more entities that match the one or more categorical identifiers and (ii) the one or more search radii; and
generate one or more responses to the one or more search queries based on the one or more entities.

16. The computing system of claim 15, wherein the one or more processors are further configured to:
generate one or more search query embeddings based on the one or more search queries;
generate one or more categorical description embeddings based on the one or more categorical descriptions; and
match the one or more search queries to the one or more categorical descriptions based on a comparison of the one or more search query embeddings associated with respective ones of the one or more search queries with the one or more categorical description embeddings associated with respective ones of the one or more categorical descriptions.

17. The computing system of claim 16, wherein the one or more processors are further configured to determine a cosine similarity or a K-nearest neighbor between the one or more search query embeddings and the one or more categorical description embeddings.

18. The computing system of claim 15, wherein the one or more processors are further configured to train the transformer machine learning model based on one or more time-stamped directed graphs associated with the user, wherein one of the one or more time-stamped directed graphs comprises (i) one or more historical query response interactions associated with the user and (ii) one or more user activity data entries comprising one or more confirming actions of the user.

19. The computing system of claim 15, wherein the one or more processors are further configured to generate the one or more mappings by:
extracting one or more user locales from one or more user activity data entries associated with a plurality of users;
determining one or more entity locales and one or more respective categorical identifiers associated with the one or more entity locales for respective one or more entities present in the one or more user activity data entries;
determining, for an entity locale of the one or more entity locales, an approximate distance between the user locale and the entity locale; and
mapping the approximate distance to a respective one of the one or more respective categorical identifiers associated with the entity locale.

20. One or more non-transitory computer-readable storage media including instructions that, when executed by one or more processors, cause the one or more processors to:
receive one or more search queries from a user;
determine, using a transformer machine learning model, one or more categorical identifiers for the one or more search queries based on one or more matches of the one or more search queries to one or more categorical descriptions associated with the one or more categorical identifiers;
determine a user locale associated with the user;
determine one or more distance preferences of the user locale based on one or more mappings of the one or more categorical identifiers to one or more statistical distances associated with the user locale;
determine one or more search radii based on the one or more distance preferences and the one or more categorical identifiers;
identify one or more entities based on (i) one or more entity activity data entries associated with the one or more entities that match the one or more categorical identifiers and (ii) the one or more search radii; and
generate one or more responses to the one or more search queries based on the one or more entities.
